(19) United States
(12) Patent Application Publication
(10) Pub. No.: US 2020/0413187 A1
(43) Pub. Date: Dec. 31, 2020

(54) MICROPHONE ARRAY, RECORDING APPARATUS, RECORDING METHOD, AND PROGRAM

(71) Applicant: Sony Corporation, Tokyo (JP)

(72) Inventors: Weihsiang Liao, Tokyo (JP); Keiichi Osako, Tokyo (JP); Yuhki Mitsufuji, Tokyo (JP)

(73) Assignee: Sony Corporation, Tokyo (JP)

(21) Appl. No.: 16/976,044

(22) PCT Filed: Feb. 15, 2019
(86) PCT No.: PCT/JP2019/005555

§ 371 Date: Aug. 26, 2020

(30) Foreign Application Priority Data
Mar. 2, 2018 (JP) 2018-037373

(51) Int. Cl. H04R 1/40; H04R 3/00

(52) U.S. Cl. CPC H04R 1/40; H04R 2201/401; H04R 3/005

(57) ABSTRACT

The present technology relates to a microphone array, a recording apparatus, a recording method, and a program that make it possible to perform broadband sound field recording at low cost.

A microphone array is a microphone array used for sound field recording that includes a plurality of sub-arrays. Further, the sub-array includes a plurality of microphones, and has a discretely rotationally symmetric shape having a specified radius, in which when values of the radiuses of the plurality of sub-arrays form a progression, the progression is a generalized arithmetic progression. The present technology is applicable to, for example, a microphone array and a recording apparatus.

### TECHNICAL FIELD

The present technology relates to a microphone array, a recording apparatus, a recording method, and a program, and, in particular, to a microphone array, a recording apparatus, a recording method, and a program that make it possible to perform broadband sound field recording at low cost.

### BACKGROUND ART

In recent years, recording and reproduction of wavefront of sound has become common in the audio industry. Technologies of synthesizing and reconstructing wavefront make it possible to localize a sound image of an object arranged in a space and to perform spatial noise cancellation, and thus to provide a realer acoustic experience, compared to multichannel reproduction techniques in the past.

For example, an open circular microphone array that includes an omnidirectional microphone is used for various applications.

However, such a design of a microphone arrangement of a circular microphone array is not suitable to record wavefront (sound field) over a wide frequency range. The reason is that, when a circular microphone array is used, a mode function that is known as a Bessel function for obtaining a spherical harmonic coefficient of recorded wavefront of sound, is zero in a specified frequency range.

Thus, for example, in order to reduce a region in which the mode function is zero, a plurality of microphones is arranged in a multiple circular form of double or more, a cardioid directional microphone is used (for example, refer to Non-Patent Literature 1), or a rigid baffle is used.

Further, in addition, there exist some array recording techniques using an omnidirectional microphone (for example, refer to Non-Patent Literatures 2 and 3, and Patent Literatures 1 to 3).

### CITATION LIST

### Non-Patent Literature

Non-Patent Literature 1: G. Huang, “Design of robust concentric circular differential microphone arrays”, The Journal of the Acoustical Society of America, 2017.

Non-Patent Literature 2: Z. Prime and C. Doolan, “A comparison of popular beamforming arrays”, Proceedings of Acoustics 2013 Victor Harbor: Science Technology and Amenity, Annual Conference of the Australian Acoustical Society, 2013.

Non-Patent Literature 3: D. Mandal, S. P. Ghoshal and A. K. Bhattacharjee, “Concentric circular antenna array synthesis using Particle Swarm Optimization with Constriction Factor Approach”, Indian Antenna Week: A Workshop on Advanced Antenna Technology, 2010.

### Patent Literature

Patent Literature 1: U.S. Pat. No. 6,205,224

Patent Literature 2: Japanese Unexamined Patent Application Publication No. 2005-521283

Patent Literature 3: Japanese Patent Application Laid-open No. 2011-15050

### DISCLOSURE OF INVENTION

### Technical Problem

However, it is difficult to perform broadband sound field recording at low cost using the technologies described above.

For example, it is not possible to perform sound field recording over a sufficiently wide frequency range in many situations by applying an approach such as arranging a plurality of microphones in a multiple circular form, using a cardioid directional microphone, or using a rigid baffle, or it is difficult to perform sound field recording over a sufficiently wide frequency range in terms of costs or due to physical restriction.

Further, the technologies disclosed in Non-Patent Literature 2 and Patent Literatures 1 to 3 are technologies for reducing a side lobe for beamforming, and the technology disclosed in Non-Patent Literature 3 is not intended for sound. Thus, these array recording techniques are not suitable for recording for reproducing wavefront.

The present technology has been made in view of the circumstances described above and it is an object thereof to perform broadband sound field recording at low cost.

### Solution to Problem

A microphone array of a first aspect of the present technology is a microphone array used for sound field recording that includes a plurality of sub-arrays each including a plurality of microphones, and each having a discretely rotationally symmetric shape having a specified radius, in which when values of the radiuses of the plurality of sub-arrays form a progression, the progression is a generalized arithmetic progression.

In the first aspect of the present technology, the microphone array is a microphone array used for sound field recording that includes a plurality of sub-arrays; the sub-arrays includes a plurality of microphones, and has a discretely rotationally symmetric shape having a specified radius; and, when values of the radiuses of the plurality of sub-arrays form a progression, the progression is a generalized arithmetic progression.

A recording apparatus of a second aspect of the present technology includes a spherical harmonic coefficient calculator that calculates a spherical harmonic coefficient on the basis of a multichannel signal obtained by sound collection being performed by a microphone array used for sound field recording, the microphone array including a plurality of sub-arrays each including a plurality of microphones, and each having a discretely rotationally symmetric shape having a specified radius, in which when values of the radiuses of the plurality of sub-arrays form a progression, the progression is a generalized arithmetic progression.

A recording method or a program of the second aspect of the present technology is a recording method or a program that corresponds to the recording apparatus of the second aspect of the present technology.

In the second aspect of the present technology, a spherical harmonic coefficient is calculated on the basis of a multichannel signal obtained by sound collection being performed by a microphone array used for sound field recording that includes a plurality of sub-arrays. Further, the plurality of sub-arrays each include a plurality of microphones, and each have a discretely rotationally symmetric shape having a specified radius, in which when values of the radiuses of the plurality of sub-arrays form a progression, the progression is a generalized arithmetic progression.

### Advantageous Effects of Invention

The first and second aspects of the present technology make it possible to perform broadband sound field recording at low cost.

Note that the effect described here is not necessarily limitative, and any of the effects described in the present disclosure may be provided.

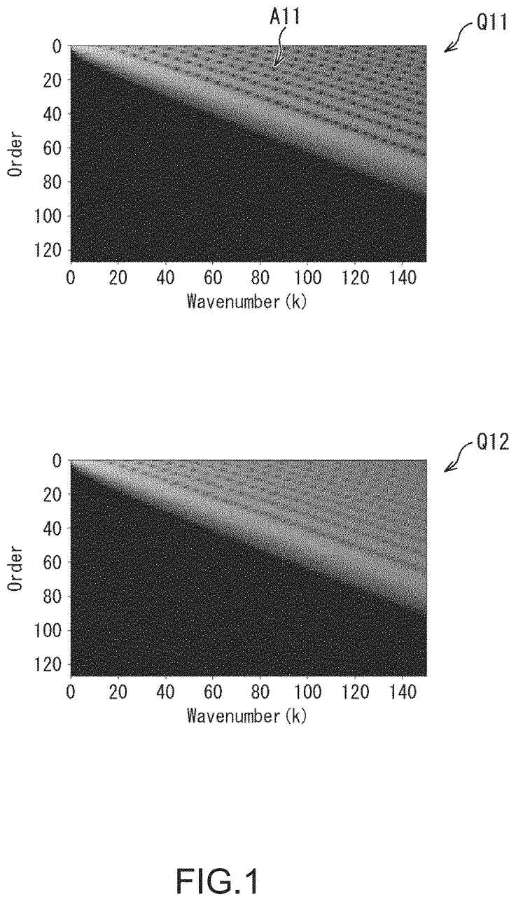

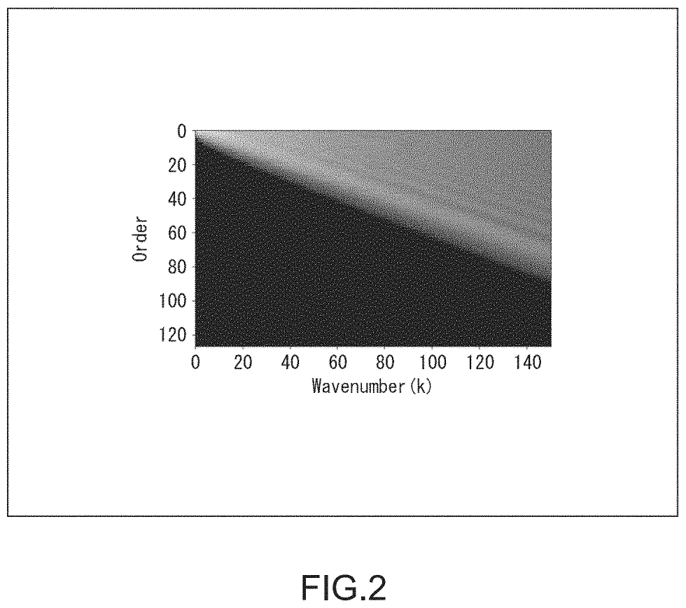

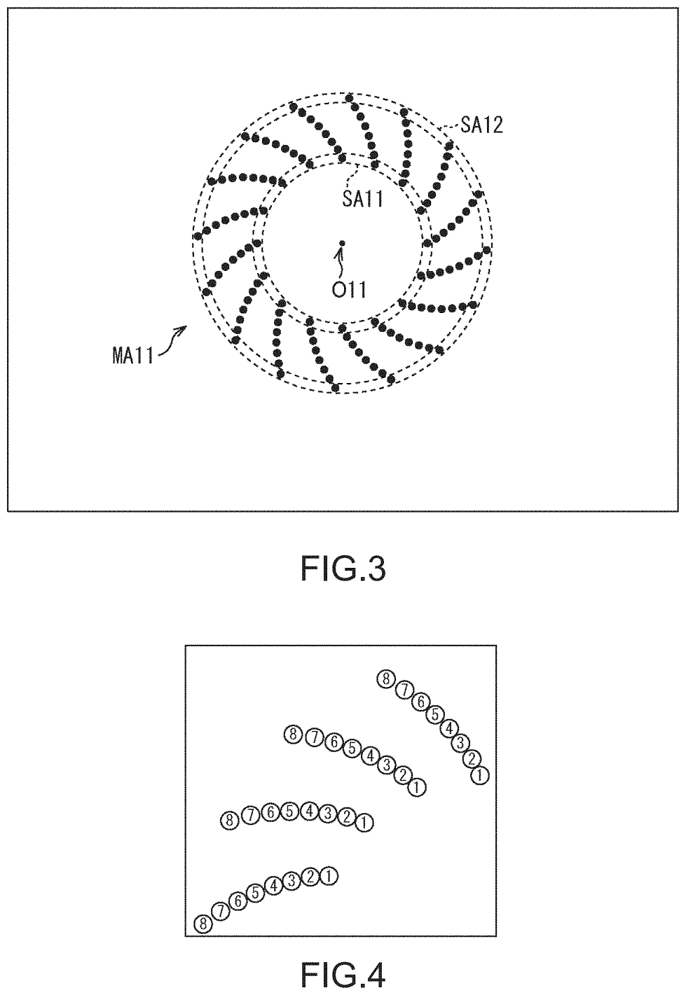

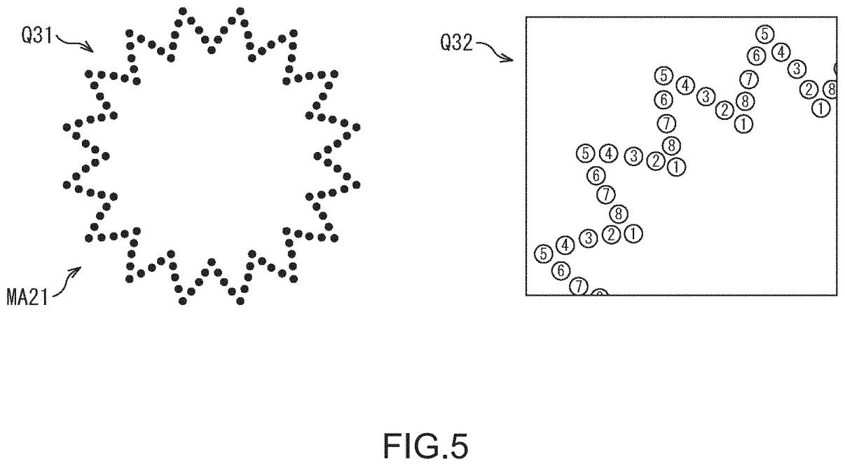

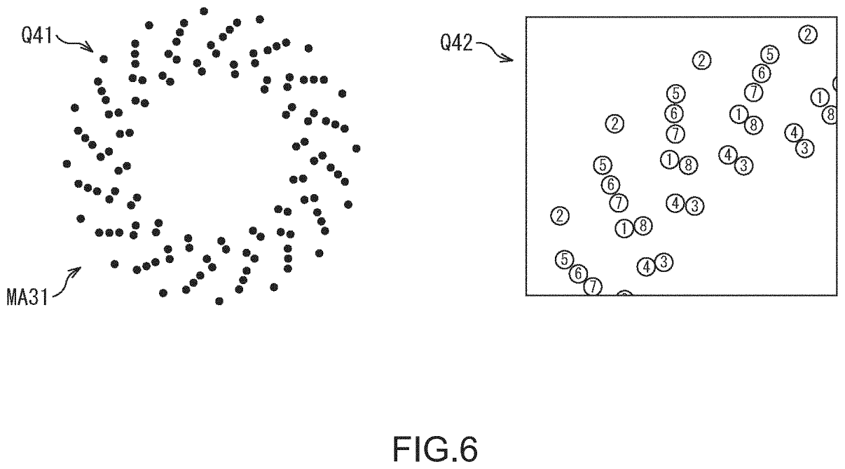

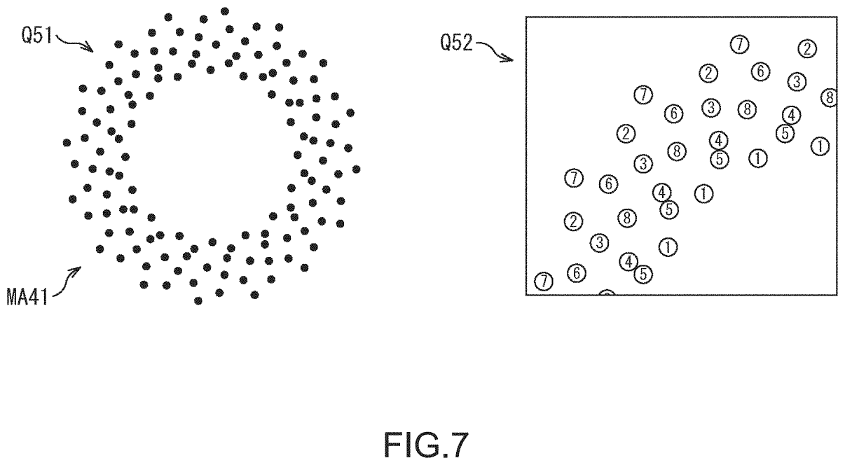

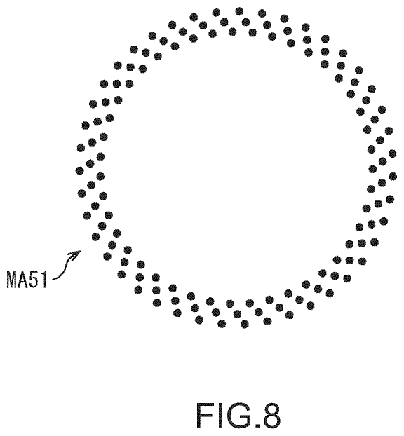

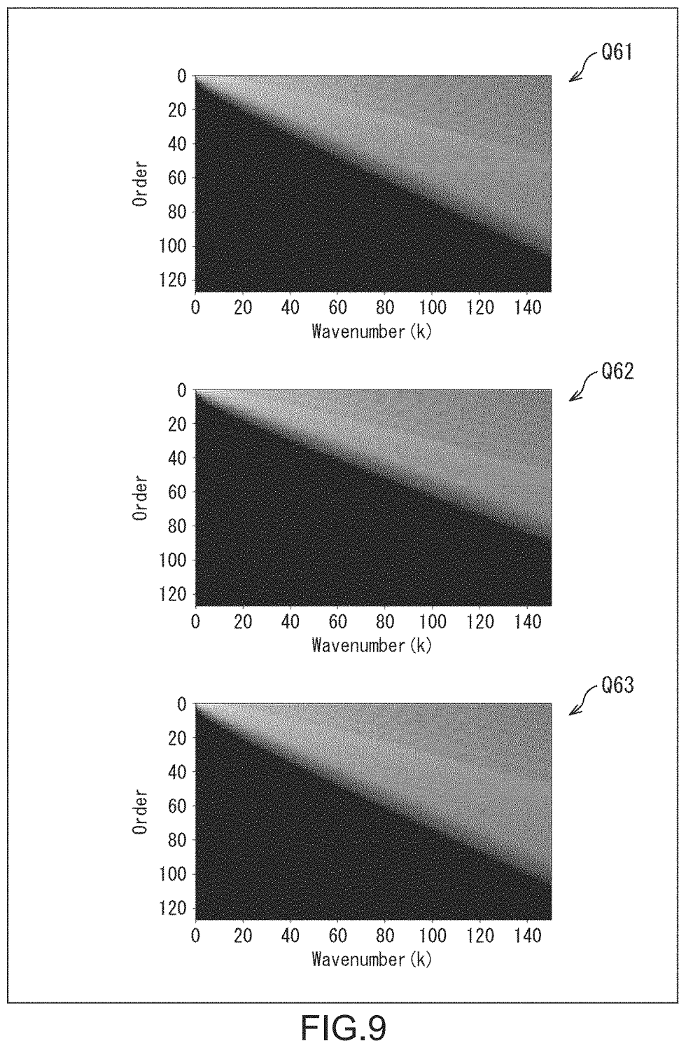

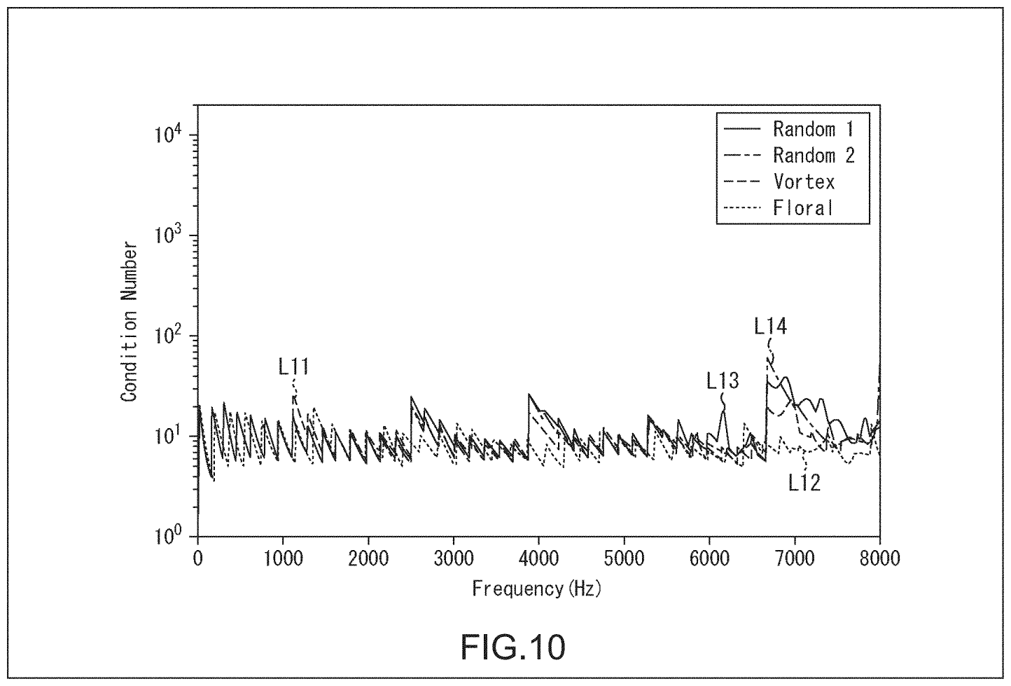

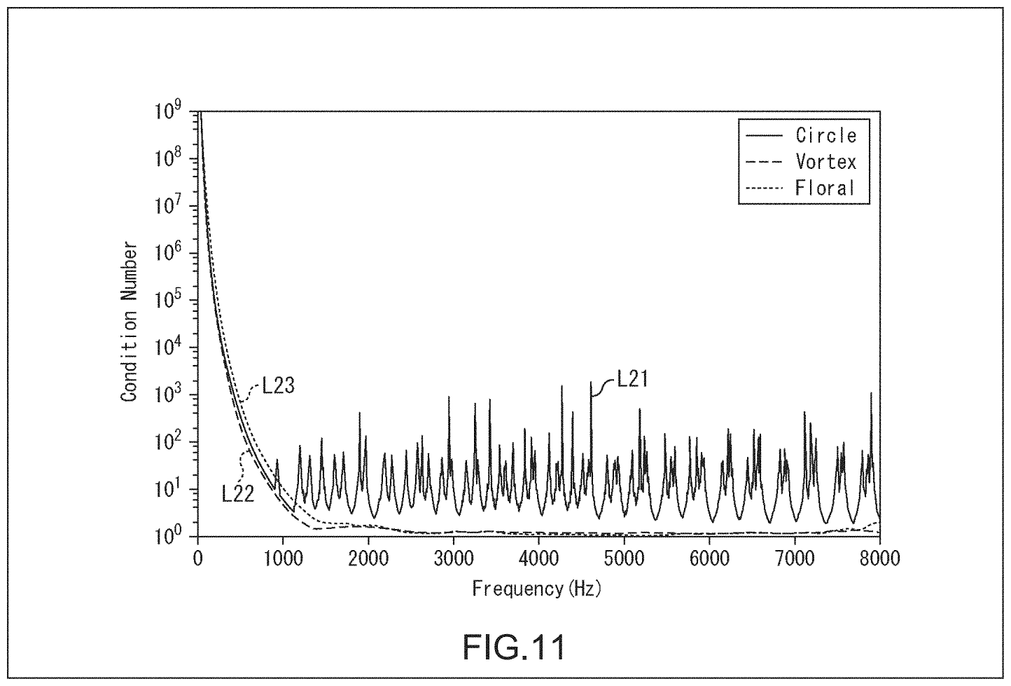

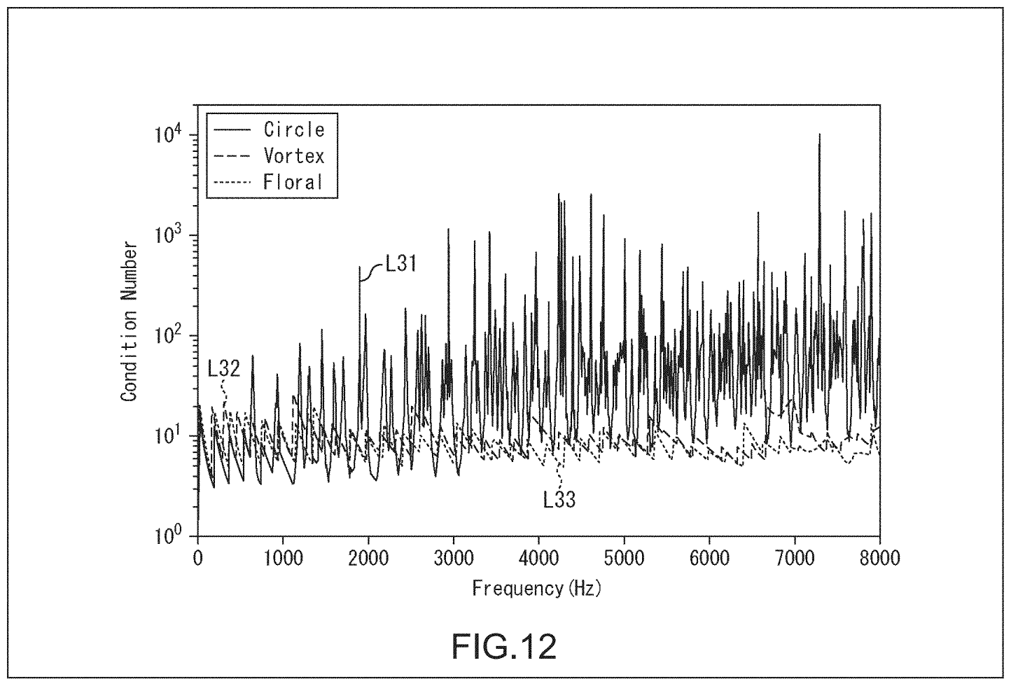

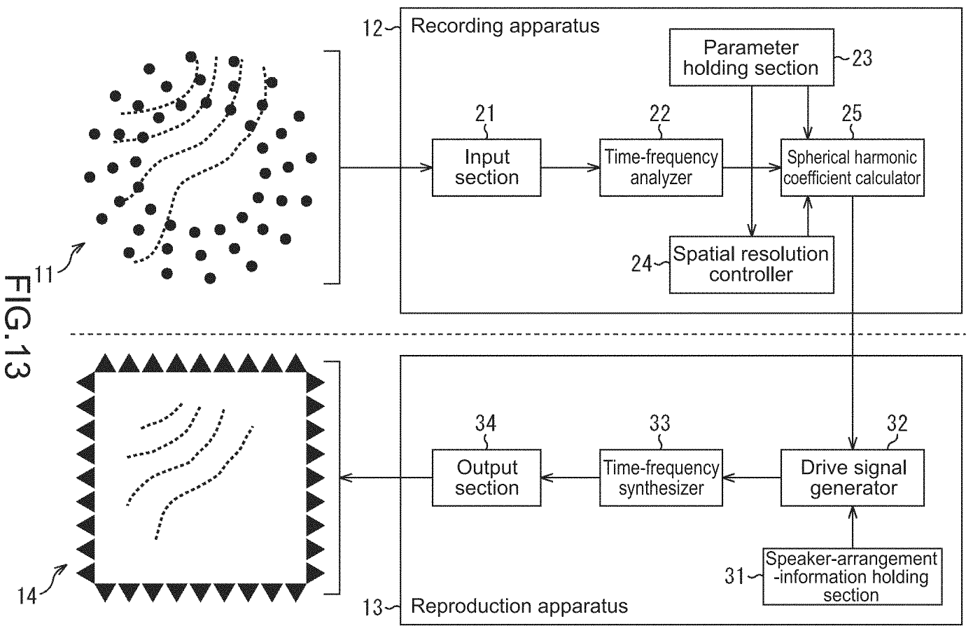

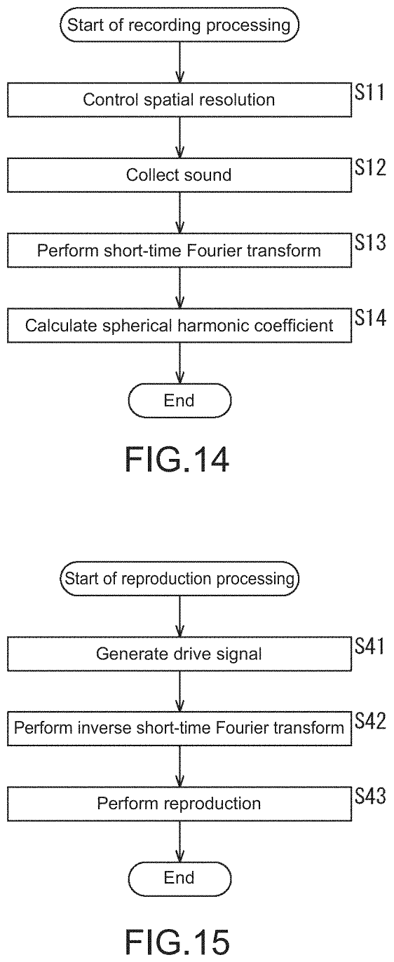

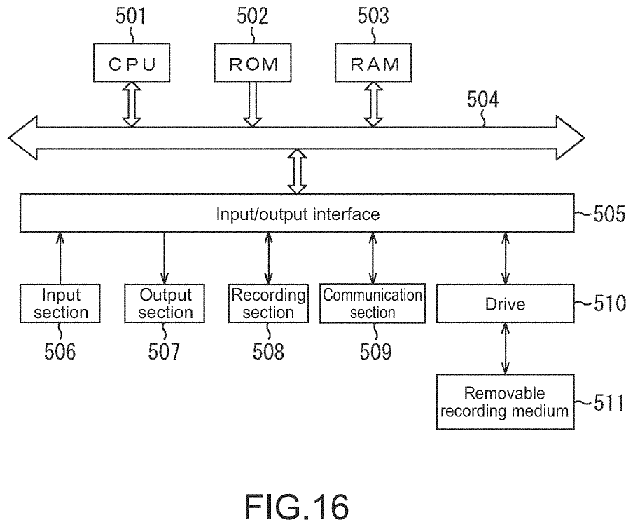

### BRIEF DESCRIPTION OF DRAWINGS

[FIG. 1] FIG. 1 is a diagram describing a value of a mode function depending on the arrangement of a microphone.

[FIG. 2] FIG. 2 is a diagram describing the value of the mode function depending on the arrangement of a microphone.

[FIG. 3] FIG. 3 illustrates an example of a configuration of a microphone array according to the present technology.

[FIG. 4] FIG. 4 is a diagram describing the arrangement of a microphone.

[FIG. 5] FIG. 5 illustrates an example of the configuration of the microphone array according to the present technology.

[FIG. 6] FIG. 6 illustrates an example of the configuration of the microphone array according to the present technology.

[FIG. 7] FIG. 7 illustrates an example of the configuration of the microphone array according to the present technology.

[FIG. 8] FIG. 8 illustrates an example of the configuration of the microphone array according to the present technology.

[FIG. 9] FIG. 9 is a diagram describing the value of the mode function depending on the arrangement of a microphone.

[FIG. 10] FIG. 10 is a diagram describing a condition number depending on the arrangement of a microphone.

[FIG. 11] FIG. 11 is a diagram describing the condition number depending on the arrangement of a microphone.

[FIG. 12] GIG. 12 is a diagram describing the condition number depending on the arrangement of a microphone.

[FIG. 13] FIG. 13 illustrates an example of configurations of a recording system and a reproduction system according to the present technology.

[FIG. 14] FIG. 14 is a flowchart describing recording processing.

[FIG. 15] FIG. 15 is a flowchart describing reproduction processing.

[FIG. 16] FIG. 16 illustrates an example of a configuration of a computer.

### MODE(S) FOR CARRYING OUT THE INVENTION

### First Embodiment

### Regarding Present Technology

The present technology makes it possible to record and reproduce a planar sound field over a wide frequency range by use of a geometrical arrangement of a microphone array.

The present technology makes it possible to parametrically determine the arrangement of each microphone, that is, the arrangement of each mike unit in a microphone array. Note that it is sufficient if an arrangement parameter that defines a mike-unit arrangement is appropriately determined depending on various use cases. For example, the microphone array includes a plurality of sub-arrays each including a plurality of microphones and each having a discretely rotationally symmetric shape, and these sub-arrays have a similar shape to one another.

The present technology described above makes it possible to improve robustness against an error in a placement of a microphone and an error due to, for example, a manufacturing variation in a microphone, and to record and reproduce a sound field, that is, wavefront of sound over a wider frequency range. Further, it is also possible to easily satisfy requirements for costs of a microphone and a mike-unit performance such as a signal-to-noise ratio (SNR).

Embodiments according to the present technology are described below with reference to the drawings.

A microphone array according to the present technology that is used sound field recording is typically a substantially circular microphone array in which respective microphones are arranged in a two-dimensional plane to surround the center of the microphone array. However, the configuration is not limited to this, and the microphone array may be a microphone array that is used to record a three-dimensional sound field and in which respective microphones are arranged in a three-dimensional space.

In other words, when microphones are arranged in a three-dimensional space, the microphone array according to the present technology may be, for example, a substantially spherical microphone array in which the respective microphones are arranged in a three-dimensional space to surround the center of the microphone array.

The description is continued below on the assumption that the microphone array according to the present technology has a structure obtained by arranging respective microphones in a two-dimensional plane.

If there exists a zero of a Bessel function when a signal of wavefront of sound (a sound field) that is recorded by a microphone array is converted into a signal of a spherical harmonic domain, there will be a frequency range in which the conversion is not accurately performed.

For example, if the microphone array is in a single or double circular form, there will be a frequency range in which the value of a mode function, that is, the value of a Bessel function is zero, as illustrated in FIG. 1.

Note that, in FIG. 1, the horizontal axis represents a wavenumber, and the vertical axis represents an order of a spherical harmonic domain. Further, light and dark in FIG. 1 represents a value of a Bessel function, and, in particular, a region of a portion in black indicates a region in which the value of a Bessel function is 0 (zero).

More specifically, the value of a Bessel function illustrated in FIG. 1 is a maximum value from among values of a Bessel function for each microphone included in the microphone array. The value of a Bessel function for each microphone varies depending on a distance from the center of the microphone array to the microphone.

In FIG. 1, a portion indicated by an arrow Q11 represents a value of a Bessel function in each region that corresponds to a wavenumber and an order when the microphone array is in a single circular form. In this example, for example, the value of a Bessel function is zero in many regions such as the region indicated by the arrow Q11, and this shows that there is a frequency range in which wavefront is not accurately recorded or reproduced.

On the other hand, a portion indicated by an arrow Q12 represents a value of a Bessel function in each region that corresponds to a wavenumber and an order when the microphone array is in a double circular form. This example shows that a region in which the value of a Bessel function is zero is smaller than that in the example indicated by the arrow Q11. However, with respect to the value of a Bessel function, there exists a large number of small values close to zero, and this may affect recording and reproduction of wavefront badly.

Likewise, as illustrated in, for example, FIG. 2, the use of a cardioid directional microphone as the microphone included in the microphone array makes it possible to reduce a region in which the value of a Bessel function is zero, but this results in a high cost.

Note that, in FIG. 2, the horizontal axis represents a wavenumber, and the vertical axis represents an order of a spherical harmonic domain. Further, light and dark in FIG. 2 represents a value of a mode function, that is, a value of a Bessel function, and, in particular, a region of a portion in black indicates a region in which the value of a Bessel function is 0 (zero). More specifically, the value of a Bessel function illustrated in FIG. 2 is a maximum value from among values of a Bessel function for each microphone included in the microphone array.

In the example illustrated in FIG. 2, with respect to a region of a certain order or less in each wavenumber, there exist few regions in which the value of a Bessel function is zero, compared to the example illustrated in FIG. 1, but the use of a cardioid directional microphone results in a high cost.

Further, although some array recording techniques using an omnidirectional microphone have been proposed in the past, these techniques are not suitable to perform recording for a reproduction of wavefront of sound.

On the other hand, there is also a simple method for avoiding a state in which the value of a Bessel function is a zero. For example, when a microphone array in a double circular form is used, and when the value of a Bessel function in one circular microphone array is zero and the value of the Bessel function in the other circular microphone array is not zero, the value of the Bessel function that is not zero may be used. However, in this method, a signal of a spherical harmonic domain is not obtained with a sufficient degree of accuracy.

In general, it is not possible to avoid sensor noise specific to a microphone or ambient noise. Further, due to an error in placement of a microphone or a manufacturing variation in a microphone, it becomes difficult to cause an actual arrangement position of a microphone and an arrangement position represented by a theoretically designed coordinate to coincide accurately.

Due to division being performed by a small value of a Bessel function at the time of reproducing recorded wavefront, these pieces of noise become bigger and an error in placement and an error due to, for example, a manufacturing variation become larger, and this results in affecting a numerical calculation badly. Thus, it is important not only to perform a method for avoiding a state in which the value of a Bessel function is a zero, but also to optimize or analyze tolerance for an error upon designing a microphone arrangement.

In other words, in order to record and reproduce wavefront more accurately, there is a need for a high tolerance for an error, that is, robustness against an error. In particular, considering costs, physical restrictions, and ease of performing signal processing, there is a need to design a microphone arrangement that achieves a high tolerance for an error and is intended for use of a minimum number of omnidirectional microphones.

Here, recording and reproduction of wavefront of sound, that is, recording and reproduction of a sound field is described. Note that the microphone included in the microphone array is hereinafter also specifically referred to as a mike unit.

For example, it is possible to record and reproduce wavefront of sound by obtaining a spherical harmonic coefficient of the wavefront.

Specifically, when a circular microphone array is used to record wavefront, a spherical harmonic coefficient aₘₙ(k) is obtained by sampling a sound pressure pₖ(r, θ_{q}, φ_{q}) of the wavefront at Q respective points under the condition that the conditions of the sampling theorem are satisfied.

Further, a component that is included in the sound pressure pₖ(r, θ_{q}, φ_{q}) and depends on a radius r of the circular microphone array is removed by dividing the sound pressure by bₙ(kr), which is a component depending on the radius r.

In other words, the spherical harmonic coefficient aₘₙ(k) can be obtained using Formula (1) below.

$$\begin{matrix}[ Formula 1 ] & \\ {a}_{m n} ( k ) = {\sum }_{q = 0}^{Q - 1} \frac{{p}_{k} ( r , {θ}_{q} , {φ}_{q} )}{{b}_{n} ( kr )} {Y}_{n}^{* m} ( {θ}_{q} , {φ}_{q} ) , k = \frac{2 π f}{{c}_{s}} , \\ {c}_{s} = wavespeed & ( 1 )\end{matrix}$$

Note that, in Formula (1), n and m each represent an order of a spherical harmonic domain, and q is an index that represents each of the Q points at which sampling is performed on the sound pressure, where q=0, . . . , Q−1. A sampling point represented by the index q is hereinafter also referred to as a point q.

Further, k represents a wavenumber, and r represents a radius of the circular microphone array, that is, a distance from a center position of the circular microphone array to a mike unit. θ_{q} and φ_{q} respectively represent an elevation and an azimuth that each indicate a direction in which a mike unit situated at a point q is oriented.

Furthermore, in Formula (1), f represents a frequency, cₛ represents a speed of sound, bₙ(kr) represents a mode function, and Y*^{m}ₙ(θ_{q}, φ_{q}) represents a spherical harmonic basis. In particular, when the circular microphone array includes an omnidirectional microphone, bₙ(kr), which is a mode function, is a spherical Bessel function. bₙ(kr) is hereinafter also simply referred to as a Bessel function. Further, “*” in the spherical harmonic basis Y*^{m}ₙ(θ_{q}, φ_{q}) represents a complex conjugate.

Note that an example in which a circular microphone array includes an omnidirectional microphone is disclosed in detail in, for example, “B. Rafaely, Fundamentals of Spherical Array Processing, Springer, 2015.” (hereinafter also referred to as Reference Document 1).

Further, operation processing in Formula (1), and, in particular, division processing of performing division by the Bessel function bₙ(kr) in Formula (1) is also referred to as mode compensation. Note that the mode compensation is disclosed in detail in, for example, “D. P. Jarrett, E. A. Habets and P. A. Naylor, Theory and Applications of Spherical Microphone Array Processing, Springer, 2017.” (hereinafter also referred to as Reference Document 2).

When sound is collected at each point q using a circular microphone array, and when wavefront of sound is recorded by obtaining the sound pressure pₖ(r, θ_{q}, φ_{q}) at the point q, the spherical harmonic coefficient aₘₙ(k) can be obtained by use of the obtained sound pressure pₖ(r, θ_{q}, φ_{q}) using Formula (1). Further, when the spherical harmonic coefficient aₘₙ(k) obtained as described above is transmitted to a reproduction system, the reproduction system can reproduce wavefront of sound (a sound field) using the spherical harmonic coefficient aₘₙ(k).

By the way, a numerical problem called a Bessel zero problem occurs when the value of the Bessel function bₙ(kr) in Formula 1 is close to zero. In other words, as described below, a condition number of a transformation matrix used to obtain the spherical harmonic coefficient aₘₙ(k) becomes large when the value of the Bessel function bₙ(kr) gets close to zero, and this results in being unable to obtain an accurate spherical harmonic coefficient aₘₙ(k).

When respective mike units included in the circular microphone array are not situated on the same ring shape, that is, when the respective mike units arranged at the respective points q have different radiuses r_{q}, the sound pressure pₖ(r, θ_{q}, φ_{q}) sampled at the point q is represented by Formula (2) below. Note that the radius r_{q} of a mike unit corresponds to a distance from the center of the circular microphone array to the mike unit, that is, a distance from the center of the circular microphone array to the point q.

$$\begin{matrix}[ Formula 2 ] & \\ {p}_{k} ( {r}_{q} , {θ}_{q} , {φ}_{q} ) = {\sum }_{n = 0}^{N} {\sum }_{m = - n}^{n} {a}_{mn} ( k ) {b}_{n} ( {kr}_{q} ) {Y}_{n}^{m} ( {θ}_{q} , {φ}_{q} ) & ( 2 )\end{matrix}$$

In this case, the spherical harmonic coefficient aₘₙ(k) of each order and wavenumber is obtained by multiplying, by B⁺ₖ, a distribution of the sound pressures pₖ(r, θ_{q}, φ_{q}) obtained at the respective points q, that is, a vector pₖ made up of the sound pressures pₖ(r, θ_{q}, φ_{q}), where B⁻ₖ is a pseudo-inverse matrix of a transformation matrix Bₖ.

In other words, for example, a vector a(k) made up of the spherical harmonic coefficients aₘₙ(k) of the wavenumber k can be obtained by performing calculation of Formula (3) below.

[Formula 3]

a(k)=Bₖ⁺pₖ (3)

In Formula (3), B⁺ₖ represents a pseudo-inverse matrix of the transformation matrix Bₖ. Note that the vector pₖ is a vector made up of the sound pressures pₖ(r, θₗ, φₗ) at respective points l, as indicated in Formula (4) below, where l=0, . . . , L, and L=Q−1. In other words, in Formula (4), l represents an index indicating a sampling point of a sound pressure, and l corresponds to q described above.

Further, as indicated in Formula (5) below, the transformation matrix Bₖ is a matrix of which an element is a product of a Bessel function bₙ(krₗ) and a spherical harmonics Y^{m}ₙ(θₗ, φₗ) with respect to the order n of each point l, where 0≤n≤N.

$$\begin{matrix} [ Formula 4 ] & \\ {p}_{k} = [ \begin{matrix}{p}_{k} ( {r}_{0} , {θ}_{0} , {φ}_{0} ) \\ {p}_{k} ( {r}_{1} , {θ}_{1} , {φ}_{1} ) \\ ⋮ \\ {p}_{k} ( {r}_{L} , {θ}_{L} , {φ}_{L} )\end{matrix} ] , L = Q - 1 & ( 4 ) \\ [ Formula 5 ] & \\ {B}_{k} = [ \begin{matrix}{b}_{0} ( {kr}_{0} ) {Y}_{0}^{0} ( {θ}_{0} , {φ}_{0} ) & {b}_{0} ( {kr}_{0} ) {Y}_{1}^{- 1} ( {θ}_{0} , {φ}_{0} ) & ⋯ & {b}_{0} ( {kr}_{0} ) {Y}_{N}^{N} ( {θ}_{0} , {φ}_{0} ) \\ ⋮ & ⋮ & & ⋮ \\ {b}_{0} ( {kr}_{L} ) {Y}_{0}^{0} ( {θ}_{L} , {φ}_{L} ) & {b}_{1} ( {kr}_{L} ) {Y}_{1}^{- 1} ( {θ}_{L} , {φ}_{L} ) & ⋯ & {b}_{N} ( {kr}_{L} ) {Y}_{N}^{N} ( {θ}_{L} , {φ}_{L} )\end{matrix} ] & ( 5 )\end{matrix}$$

In Formula (3) described above, Y*^{m}ₙ(θ_{q}, φ_{q})/bₙ(kr) indicated in Formula (1) is replaced by the pseudo-inverse matrix B⁺ₖ in the division that is mode compensation. In order to obtain an accurate spherical harmonic coefficient aₘₙ(k) using this Formula (3), it is necessary that the transformation matrix Bₖ be invertible and avoid becoming ill-conditioned. Here, whether the transformation matrix Bₖ is well-conditioned or ill-conditioned can be evaluated by, for example, a condition number with respect to the transformation matrix Bₖ.

When a minimum singular value and a maximum singular value of the transformation matrix Bₖ are σₘᵢₙ(Bₖ) and σₘₐₓ(Bₖ) respectively, a condition number X(k) of the transformation matrix Bₖ can be obtained using Formula (6) below.

$$\begin{matrix}[ Formula 6 ] & \\ X ( k ) = ‖ {B}_{k} ‖ \cdot ‖ {B}_{k}^{+} ‖ = \frac{{σ}_{m ax} ( {B}_{k} )}{{σ}_{m i n} ( {B}_{k} )} & ( 6 )\end{matrix}$$

In the calculation of Formula (3), when an error is included in an observed vector, that is, the vector pₖ in this case, the error is increased X(k)-fold, where X(k) represents a condition number.

Thus, the condition number X(k) of the transformation matrix Bₖ is favorably smaller, and a small condition number X(k) indicates a high tolerance for an error, that is, an improved robustness against an error. Empirically, a matrix of which a condition number is more than 100 is ill-conditioned, although it depends on an application. Note that analysis of tolerance for an error of a circular microphone array or a spherical microphone array that is performed on the basis of a condition number, is disclosed in detail in, for example, Reference Document 1 described above.

As described above, the spherical harmonic coefficient aₘₙ(k) used to reproduce wavefront of sound can be obtained by performing calculation of Formula (3), and a well-conditioned transformation matrix Bₖ can be obtained by appropriately setting the arrangement of each mike unit included in the microphone array and a maximum value of the order n (a maximum order) of a spherical harmonic domain.

Thus, the present technology makes it possible to achieve a high tolerance for noise (a high tolerance for an error) over a wide frequency range using fewer omnidirectional mike units, that is, at low cost, by appropriately setting the arrangement of a mike unit and a maximum order of a spherical harmonic domain.

In particular, recording and reproduction of wavefront according to the present technology is performed by parametrically designing a microphone array having features described below and by performing spatial resolution control depending on frequency.

For example, a microphone array according to the present technology has Features F1 to F3 below. In other words, the microphone array according to the present technology is designed on the basis of Features F1 to F3 below.

### Feature F1

The microphone array includes a plurality of geometrically similar sub-arrays, and each sub-array is discretely rotationally symmetric.

### Feature F2

The mike units are distributed at an equal angle as viewed from the center of the microphone array.

### Feature F3

When values of radiuses of the respective sub-arrays form a progression, the progression is a generalized arithmetic progression.

The microphone array according to the present technology includes a plurality of sub-arrays, and each sub-array includes a plurality of mike units.

Note that the microphone array may include a single sub-array, or the sub-array may include a single mike unit.

Further, all of the mike units included in the microphone array are essentially omnidirectional microphones, but some of the mike units may be microphones that are not omnidirectional ones.

Feature F1 described above is a feature in which, when the microphone array includes a plurality of sub-arrays, all of the sub-arrays have geometrically similar shapes (are in similar mike-unit arrangements). Here, sub-arrays being geometrically similar to one another refers to pluralities of mike units included in the sub-arrays being in similar arrangements.

For example, two sub-arrays being geometrically similar to each other refers to one of the sub-arrays coinciding with the other sub-array when at least one of an enlargement operation, a reduction operation, a rotation operation, or a reverse operation is performed on the one of the sub-arrays.

Here, the coinciding refers to an arrangement position of each mike unit included in one of the sub-arrays coinciding with an arrangement position of each mike unit included in the other sub-array after the operation of, for example, enlargement is performed on the one of the sub-arrays. In this case, a center position of each sub-array coincides with a center position of the microphone array.

Further, each sub-array has a discretely rotationally symmetric shape. In other words, the sub-array does not have continuous rotational symmetry in which the sub-array constantly has the same shape when the sub-array is rotated by an arbitrary angle, but the sub-array has discrete rotational symmetry in which the shapes of the sub-array before and after being rotated coincide when the sub-array is rotated by a specified angle about a center position of the sub-array, that is, a center position of the microphone array. In the microphone array, it is possible to achieve flat frequency characteristics since each sub-array is discretely rotationally symmetric.

Furthermore, each sub-array has a specified radius. In particular, in this case, all of the mike units included in the sub-array have an equal radius, and this radius corresponds to a radius of the sub-array. The radius of a mike unit corresponds to a distance from a center position of the sub-array, that is, from a center position of the microphone array to the mike unit.

Thus, each of the plurality of mike units included in the sub-array is arranged away from the center position of the microphone array, that is, the center position of the sub-array by a distance corresponding to the radius of the sub-array.

Feature F2 is a feature in which, when all of the mike units included in the microphone array are radially projected onto a single ring shape centered at a center position of the microphone array, that is, onto the circumference of the microphone array, the projected mike units are uniformly distributed on the ring shape. In other words, the projected mike units are equally spaced on the ring shape.

Here, the position on a ring shape at which a mike unit is projected is a position at which a line connecting (passing through) the mike unit and the center position of the microphone array intersects a ring shape (a circle) onto which the mike unit is projected. In other words, the position of a mike unit on a ring shape as viewed from the center position of the microphone array is a position onto which the mike unit is projected.

It becomes no longer necessary to perform complicated signal processing after recording of wavefront by Feature F2 described above being given. The omission of complicated signal processing due to such characteristics is disclosed in detail in, for example, Reference Document 1 described above.

Further, Feature F3 is a feature in which, when there exist sub-arrays, from among a plurality of sub-arrays included in the microphone array, that have different radiuses, and when values of radiuses of all of the sub-arrays included in the microphone array form a progression, the progression is a generalized arithmetic progression, the values of the radiuses being placed in ascending order or in descending order.

In other words, Feature 3 is a feature in which mike units are arranged at intervals corresponding to a common difference of a generalized arithmetic progression in a direction outward from the center of the microphone array, that is, in a direction away from the center.

A method for arranging mike units on the basis of a distance corresponding to a radius determined according to a logarithm or a geometric progression, are disclosed in detail in, for example, “Z. Prime and C. Doolan, “A comparison of popular beamforming arrays”, Proceedings of Acoustics 2013 Victor Harbor: Science Technology and Amenity, Annual Conference of the Australian Acoustical Society, 2013.” and U.S. Pat. No. 6,205,224.

However, when spatial resolution is controlled for each frequency, a more potent effect of reducing a region in which the value of a Bessel function is zero or nearly zero, is provided by applying the present technology to determine a radius of a sub-array using a generalized arithmetic progression, compared to applying the method described above. In other words, the condition number X(k) of the transformation matrix Bₖ becomes smaller.

Further, the microphone array designed to have Features F1 and F2 makes it possible to achieve scalable use depending on requirements by using several sub-arrays.

It is assumed that several geometrically similar sub-arrays are used as sub-arrays included in the microphone array. In this case, for example, scalable use in which the microphone array includes three sub-arrays when there is a sufficiently large number of available mike units, and the microphone array includes two sub-arrays when there is a small number of available mike units, is possible.

Further, the transformation matrix Bₖ of the microphone array depends on the frequency, that is, the wavenumber k, and spatial resolution for conversion is appropriately set for each frequency in an operation frequency range in order to obtain accurate sound-field information.

For example, when the spherical harmonic coefficient aₘₙ(k) is obtained by performing calculation of Formula (3), a more accurate spherical harmonic coefficient aₘₙ(k) is generally obtained at a higher spatial resolution if calculation is performed up to a term of a higher order n. However, with respect to a component of which the order n is not less than a specified order that is determined according to, for example, a mike-unit arrangement, the value of a Bessel function is zero or close to zero.

Thus, according to the present technology, processing of excluding (removing), from the transformation matrix Bₖ, a row corresponding to each of the orders n not less than a specified order is performed as spatial resolution control, in order to improve the condition number of the transformation matrix Bₖ. In other words, limitation is placed on the order n used to perform operation, that is, the number of rows of the transformation matrix Bₖ is limited.

In particular, the advantage the present technology has is that it is possible to record a broadband sound field (wavefront) while achieving a high tolerance for an error, using a minimum number of omnidirectional mike units.

The spatial resolution control makes it possible not only to improve tolerance for an error, but also to reduce a calculation amount.

Further, the inclusion of a plurality of sub-arrays in a microphone array makes it possible to increase the sampling density in an angular direction without using a small mike unit. The reason is that, for example, compared to when mike units are arranged in a single circular form, the arrangement of a plurality of sub-arrays makes it possible to further increase the density of projected mike units on a ring shape centered at a center position of a microphone array when the mike units are radially projected onto the ring shape.

Furthermore, the microphone array according to the present technology has a self-similar shape, that is, a fractal shape. Thus, the present technology achieves the scalability that makes it possible to form a microphone array even when only fewer number of mike units can be used. In other words, scalable use is possible as described above.

### Example of Configuration of Microphone Array

Next, a more specific example of a configuration of a microphone array according to the present technology is described. FIG. 3 illustrates an example of a configuration of an embodiment of a microphone array according to the present technology.

A microphone array MA11 illustrated in FIG. 3 is a vortex-shaped microphone array that includes a plurality of omnidirectional mike units. Note that, in FIG. 3, each point represents one mike unit.

In this example, the microphone array MA11 includes 128 mike units, and these mike units are arranged in the form of a vortex.

In the microphone array MA11, one sub-array includes 16 mike units. In other words, the microphone array MA11 includes eight sub-arrays having different radiuses, and the eight sub-arrays are concentrically arranged.

For example, a sub-array SA11 is a portion including 16 circularly arranged mike units, and, likewise, a sub-array SA12 is a portion including 16 circularly arranged mike units.

Further, the microphone array MA11 has Features F1 to F3 described above.

For example, the respective sub-arrays included in the microphone array MA11 have shapes that are different only in a scale and a rotation angle. Specifically, for example, when the sub-array SA11 is enlarged and rotated by a specified angle, the enlarged and rotated sub-array SA11 coincides with the sub-array SA12.

Further, mike units of each sub-array are arranged in the form of a circle centered at a center position 011, and this results in the sub-array having a discretely rotationally symmetric shape.

An enlarged view of a portion of the microphone array MA11 is given in FIG. 4. Note that, in FIG. 4, each circle represents one mike unit. Further, in FIG. 4, the same number is given in circles that respectively represent mike unites included in the same sub-array.

In the example illustrated in FIG. 4, for example, a mike unit given a number “1” is included in the sub-array SA11 illustrated in FIG. 3, and a mike unit given a number “8” is included in the sub-array SA12 illustrated in FIG. 3.

In particular, this example shows that the respective sub-arrays are adjacently arranged and a progression containing values of radiuses of these sub-array is a generalized arithmetic progression. In other words, with respect to any of the sub-arrays, a difference between radiuses of adjacent sub-arrays exhibits one of several predetermined values corresponding to a common difference.

Note that the microphone array MA11 illustrated in FIG. 3 is hereinafter also specifically referred to as a vortex-shaped microphone array.

Further, the example in which the microphone array includes eight sub-arrays and the sub-arrays each include 16 mike units, has been described above. However, for example, the microphone array may include four sub-arrays and each sub-array may include 32 mike units, or the microphone array may include two sub-arrays and each sub-array may include 64 mike units.

Furthermore, the microphone array according to the present technology is not limited to the microphone array illustrated in FIG. 3, and may have any configuration, as long as it has Features F1 to F3.

Specifically, for example, the microphone array may have the configuration illustrated in FIG. 5.

In other words, a microphone array MA21 formed by a plurality of omnidirectional mike units being arranged in the form of an outline of a flower, is illustrated in a portion indicated by an arrow Q31 in FIG. 5. Note that, in the portion indicated by the arrow Q31, each point represents one mike unit.

The microphone array MA21 includes eight sub-arrays, and each sub-array includes 16 circularly arranged mike units.

An enlarged view of a portion of the microphone array MA21 is given in a portion indicated by an arrow Q32. Note that, in the portion indicated by the arrow 32, each circle represents one mike unit, and the same number is given in circles that respectively represent mike unites included in the same sub-array.

This example shows that the eight sub-arrays included in the microphone array MA21 are concentrically arranged and the respective sub-arrays are adjacently arranged.

Specifically, this example shows that the sub-array including mike units given a number “2” and the sub-array including mike units given a number “8” are different in an angle of rotation centered at a center position of the microphone array MA21, that is, in an arrangement position of a mike unit in a rotational direction, but the sub-arrays have an equal radius.

Likewise, the sub-array including mike units given a number “3” and the sub-array including mike units given a number “7” are different in an angle of rotation, but have an equal radius. Further, the sub-array including mike units given a number “4” and the sub-array including mike units given a number “6” are different in an angle of rotation, but have an equal radius.

Such a microphone array MA21 has Features F1 to F3 described above. Note that the microphone array MA21 is hereinafter also specifically referred to as a flower-shaped microphone array.

Further, the microphone array according to the present technology may have the configuration illustrated in, for example, FIG. 6, 7, or 8.

In other words, for example, a microphone array MA31 formed by a plurality of omnidirectional mike units being arranged substantially in the form of a vortex, is illustrated in a portion indicated by an arrow Q41 in FIG. 6. Note that, in the portion indicated by the arrow Q41, each point represents one mike unit.

The microphone array MA31 includes eight sub-arrays, and each sub-array has Feature 1 described above. Further, each sub-array includes 16 circularly arranged mike units.

An enlarged view of a portion of the microphone array MA31 is given in a portion indicated by an arrow Q42. Note that, in the portion indicated by the arrow 42, each circle represents one mike unit, and the same number is given in circles that respectively represent mike unites included in the same sub-array.

In this example, the eight sub-arrays included in the microphone array MA31 are concentrically arranged, and the rotation angle of each sub-array upon arranging the sub-array is determined at random.

Further, for example, a microphone array MA41 formed by a plurality of omnidirectional mike units being arranged substantially in the form of a vortex, is illustrated in a portion indicated by an arrow Q51 in FIG. 7. Note that, in the portion indicated by the arrow Q51, each point represents one mike unit.

The microphone array MA41 includes eight sub-arrays, and each sub-array includes 16 circularly arranged mike units.

An enlarged view of a portion of the microphone array MA41 is given in a portion indicated by an arrow Q52. Note that, in the portion indicated by the arrow 52, each circle represents one mike unit, and the same number is given in circles that respectively represent mike unites included in the same sub-array.

In this example, the eight sub-arrays included in the microphone array MA41 are concentrically arranged, and the rotation angle of each sub-array upon arranging the sub-array is determined at random.

In the microphone arrays illustrated in FIGS. 6 and 7, the rotation angle of each sub-array is determined at random, and the microphone arrays illustrated in FIGS. 6 and 7 each have Features F1 to F3 described above. Note that such microphone arrays are hereinafter also specifically referred to as randomly shaped microphone arrays.

Further, for example, a microphone array MA51 formed by a plurality of omnidirectional mike units being arranged in a triple circular form, is illustrated in FIG. 8. Note that, in FIG. 8, each point represents one mike unit.

The microphone array MA51 includes three sub-arrays, and each sub-array includes 43 circularly arranged mike units.

Specifically, in this example, the three sub-arrays included in the microphone array MA51 are concentrically arranged, and, when one of the three sub-arrays is enlarged or reduced, and then rotated, the one of the three sub-arrays coincides with the other sub-arrays.

The microphone array having Features F1 to F3 described above makes it possible to reduce a region in which the value of a Bessel function is zero, and to improve the condition number X(k) of the transformation matrix Bₖ. For example, the adoptions of the vortex-shaped microphone array, the flower-shaped microphone array, and the randomly shaped microphone array each result in there being no region in which the value of a Bessel function is zero, as illustrated in FIG. 9.

Note that, in FIG. 9, the horizontal axis represents a wavenumber, and the vertical axis represents an order of a spherical harmonic domain. Further, light and dark in FIG. 9 represents a value of a Bessel function, and, in particular, a region of a portion in black indicates a region in which the value of a Bessel function is 0 (zero). More specifically, the value of a Bessel function illustrated in FIG. 9 is a maximum value from among values of a Bessel function for each sub-array included in a microphone array.

In FIG. 9, a portion indicated by an arrow Q61 represents a value of a Bessel function in each region that corresponds to the wavenumber k and the order n when the vortex-shaped microphone array is used.

Further, a portion indicated by an arrow Q62 represents a value of a Bessel function in each region that corresponds to the wavenumber k and the order n when the flower-shaped microphone array is used. Furthermore, a portion indicated by an arrow Q63 represents a value of a Bessel function in each region that corresponds to the wavenumber k and the order n when the randomly shaped microphone array is used.

These examples indicated by the arrows Q61 to Q63 show that, in a frequency range of from 0 kHz to 8 kHz, there exists no longer a region in which the value of a Bessel function is zero with respect to a certain order n or less, the region in which the value of a Bessel function is zero existing in the example illustrated in FIG. 1. As described above, when there exists no longer a region in which the value of a Bessel function is zero, this makes it possible to make the condition number X(k) of the transformation matrix Bₖ smaller, and thus to improve tolerance for an error over a wide frequency range at low cost.

Further, when the spatial resolution control is applied to the microphone array according to the present technology, the condition of the transformation matrix Bₖ is better if mike units projected onto a ring shape are situated closer to each other, as illustrated in, for example, FIG. 10.

Note that, in FIG. 10, the horizontal axis represents a frequency, and the vertical axis represents the condition number X(k) of the transformation matrix Bₖ. Further, in the example of FIG. 10, the condition number X(k) is a condition number when spatial resolution control described later is performed.

In this example, a curve L11 to a curve L14 respectively represent the condition numbers X(k) for the vortex-shaped microphone array MA11 illustrated in FIG. 3, the flower-shaped microphone array MA21 illustrated in FIG. 5, the randomly shaped microphone array MA31 illustrated in FIG. 6, and the randomly shaped microphone array MA41 illustrated in FIG. 7.

Here, this example shows that the condition number X(k) for the flower-shaped microphone array MA21 is smallest over an entire frequency range since the distance between mike units projected onto a ring shape is shortest in the case of the flower-shaped microphone array MA21.

On the other hand, in the cases of the vortex-shaped microphone array MA11, the distance between mike units is relatively long for every eight mike units. In other words, a mike unit included in a sub-array that is included in the microphone array MA11 and situated closest to the center, and a mike unit included in a sub-array situated farthest away from the center are arranged away from each other.

Thus, the distance between mike units projected onto a ring shape is longer than that in the case of the microphone array MA21, and the condition number X(k) for the vortex-shaped microphone array MA11 is slightly larger than the condition number X(k) for the flower-shaped microphone array MA21.

Further, in the case of the randomly shaped microphone array MA31 and the randomly shaped microphone array MA41, the distance between mike units projected onto a ring shape is relatively long. Thus, the condition numbers X(k) for the microphone arrays MA31 and MA41 are larger than the condition number X(k) for the vortex-shaped microphone array MA11.

### Regarding Arrangement Parameter of Microphone Array

By the way, as described above, the present technology makes it possible to parametrically determine the arrangement of each mike unit in a microphone array.

Here, a parameter that indicates the arrangement of each mike unit of a microphone array is referred to as an arrangement parameter, and a set of a plurality of arrangement parameters is referred to as an arrangement-parameter set. In other words, the arrangement of each mike unit included in a microphone array is determined by the arrangement-parameter set.

Specifically, examples of the arrangement parameter include the number of sub-arrays S, a radius rₛ of each sub-array (where s=0, 1, . . . , S−1), and a rotation angle φₛ of the sub-array (where s=0, 1, . . . , S−1).

Here, the number of sub-arrays S is the number of sub-arrays included in a microphone array, the radius rₛ of a sub-array corresponds to a distance from a center position of a microphone array to a mike unit included in the sub-array. A vector containing radiuses rₛ of S sub-arrays is hereinafter also referred to as a radius vector r_{sub}.

Further, the rotation angle φₛ of a sub-array is an angle of inclination of the sub-array with respect to a specified direction as viewed from a center position of a microphone array. In other words, the rotation angle φₛ of a sub-array is an angle of a rotational direction that indicates the position of the sub-array in a direction of rotation centered at a center position of a microphone array.

Specifically, for example, it is assumed that the center position of a microphone array is a center 0, and a direction, as viewed from the center 0, that is used as a specified reference is a reference direction. In this case, for example, the rotation angle φₛ is an angle between a line connecting the center 0 and a mike unit that is included in the sub-array and used as a specified reference, and the reference direction.

For example, a direction of a mike unit that is included in a sub-array situated closest to the center 0 and is used as a reference, is set to be the reference direction. In this case, the rotation angle φₛ of a sub-array indicates by which angle another sub-array situated closest to the center 0 is to be rotated such that the other sub-array coincides with the sub-array.

Note that a vector containing rotation angles φₛ of S sub-arrays is hereinafter also referred to as a rotation-angle vector φ_{sub}.

The number of sub-arrays S, the radius a vector r_{sub}, and the rotation-angle vector φ_{sub} that are the arrangement parameters are hereinafter also referred to as an arrangement-parameter set P^{Q}ₒₚₜ={S, r_{sub}, φ_{sub}}.

For example, an optimal arrangement parameter depends on a total number of microphone units Q, an operation frequency range [fₘᵢₙ, fₘₐₓ], a diameter of a mike unit Dₘ, and an upper limit Xₘₐₓ of the condition number X(k).

Here, the total number of microphone units Q is the number of mike units included in a microphone array. The number of sub-arrays included in the microphone array, that is, the number of sub-arrays S is determined by the total number of microphone units Q.

Specifically, for example, when the total number of microphone units Q is 24, a value of the number of sub-arrays S can be set to be 1, 2, 3, 4, 6, 12, or 24.

Further, the operation frequency range [fₘᵢₙ, fₘₐₓ] is a frequency range from a minimum value fₘᵢₙ to a maximum value fₘₐₓ of a frequency of a target sound.

When the arrangement-parameter set P^{Q}ₒₚₜ is determined, each arrangement parameter is optimized considering a condition number in the operation frequency range [fₘᵢₙ, fₘₐₓ].

The diameter Dₘ of a mike unit is a diameter of a mike unit included in a microphone array, and Dₘ is a lower limit of an absolute value of a common difference of a generalized arithmetic progression that determines the radius vector r_{sub}.

For example, it is assumed that the radiuses rₛ of two arbitrary sub-arrays are a radius rᵢ and a radius rⱼ (where i≠j). In this case, it is necessary that the radius rᵢ and the radius rⱼ satisfy Formula (7) below. The reason is that, even if the radius rₛ of a sub-array and the rotation angle φₛ are considered, it is not possible to physically arrange two mike units having the diameter Dₘ side by side unless the condition of Formula (7) is satisfied.

$$\begin{matrix}[ Formula 7 ] & \\ \vert {r}_{i} - {r}_{j} \vert ≧ {r}_{j} ( cos ( \frac{2 π}{Q} ) - 1 + \sqrt{{( \frac{{D}_{m}}{{r}_{j}} )}^{2} - {sin}^{2} ( \frac{2 π}{Q} )} ) , i \neq j & ( 7 )\end{matrix}$$

Further, the upper limit Xₘₐₓ is a value of the condition number X(k) that is acceptable in the operation frequency range [fₘᵢₙ, fₘₐₓ] and indicates a state of being best-conditioned (a largest value of the condition number X(k)).

Empirically, a matrix of which the condition number X(k) is more than 100 is ill-conditioned and an inverse matrix is unstable, although it depends on an application. However, since multicollinearity is not desirable in many cases, it is actually sufficient if the upper limit Xₘₐₓ is set to about 30.

It is possible to obtain a microphone array including appropriately arranged mike units by determining an optimal arrangement-parameter set P^{Q}ₒₚₜ on the basis of the total number of microphone units Q, the operation frequency range [fₘᵢₙ, fₘₐₓ], the diameter Dₘ of a mike unit, and the upper limit Xₘₐₓ of the condition number X(k) described above, such that the microphone array has Features F1 to F3.

Specifically, for example, the optimal arrangement-parameter set P^{Q}ₒₚₜ is obtained by minimizing an average condition number of the transformation matrix Bₖ in the operation frequency range [fₘᵢₙ, fₘₐₓ], with constraints imposed by the total number of microphone units Q, the diameter Dₘ, and the upper limit Xₘₐₓ.

A search for the arrangement-parameter set P^{Q}ₒₚₜ is achieved by performing an exhaustive search for possible arrangement parameters. Empirically, a substantially optimal result can be obtained by a metaheuristic optimization approach such as differential evolution.

Note that the metaheuristic optimization approach such as differential evolution is disclosed in detail in, for example, “R. Storn and K. Price, “Differential Evolution—A Simple and Efficient Heuristic for global Optimization over Continuous Spaces”, Journal of Global Optimization, 1997.” (hereinafter also referred to as Reference Document 3).

### Regarding Spatial Resolution Control

Next, spatial resolution control in a microphone array is described.

For example, in Reference Document 1 and Reference Document 2, it is favorable that an appropriate spatial resolution be selected for each frequency range to obtain a greater robustness. This implies that an appropriate selection of spatial resolution results in a well-conditioned transformation matrix.

Actually, when an arbitrary value kr is given with respect to the wavenumber k and the radius r of a microphone array and when the order n is constantly a certain high order (hereinafter referred to as n₀(kr)) or greater, the value of a corresponding mode function (Bessel function) gets closer to zero as the order n becomes higher.

For example, as indicated in Formula (8) below, the order n determined according to the total number of microphone units Q of a microphone array is represented by Nₐᵣᵣ.

[Formula 8]

n₀(kr)<Nₐᵣᵣ=[(Q−1)/2] (8)

In this case, spherical harmonic terms, that is, elements of the transformation matrix Bₖ that correspond to the order n up to Nₐᵣᵣ, which is greater than n₀(kr), do not include reliable information for reproducing wavefront. The reason is that, with respect to the order n up to Nₐᵣᵣ, which is greater than n₀(kr), the value of the Bessel function is zero or nearly zero.

Thus, according to the present technology, such a numerically small spherical harmonic term is excluded to minimize an information loss, and a condition of the transformation matrix Bₖ is improved.

In this case, processing of limiting the number of rows of the transformation matrix Bₖ is performed as spatial resolution control, the number of rows of the transformation matrix Bₖ being the number of rows used to perform operation to calculate the spherical harmonic coefficient aₘₙ(k), the operation including mode compensation.

In other words, for example, when max(rₛ) represents a maximum value of the radiuses rₛ of respective sub-arrays, a transformation matrix Bⁿ⁰ₖ obtained by performing spatial resolution control on the transformation matrix Bₖ, is a matrix that contains the first row to the no row of the transformation matrix Bₖ. In other words, due to controlling spatial resolution, the number of rows of the transformation matrix Bₖ that are used to perform operation is limited to n₀(k×max(rₛ)) rows on the basis of an order n₀(k×max(rₛ)), and the transformation matrix Bⁿ⁰ₖ is obtained as a transformation matrix in which the number of rows is limited.

Here, the n₀(k×max(rₛ))-th row of the transformation matrix Bₖ is a row corresponding to the order n₀(k×max(rₛ)). The order n₀(k×max(rₛ)) is an order with respect to a sub-array having a radius of max(rₛ). In other words, the order n₀(k×max(rₛ))is the order n₀(kr) when the radius r=max(rₛ).

Any method may be adopted as a method for determining the order n₀(kr) with respect to the radius r, and, for example, n₀(kr)=th×r may be satisfied, where the value of th, a threshold, is 1 or 1.1, or the order n₀(kr) may be determined by performing calculation of Formula (9) below. For example, the method for satisfying n₀(kr)=th×r is disclosed in detail in Reference Documents 1 and 2 described above.

$$\begin{matrix}[ Formula 9 ] & \\ {n}_{0} ( kr ) = {inf}_{n} \frac{{\sum }_{0}^{N} \vert {B}_{n} ( kr ) \vert}{{\sum }_{0}^{∞} \vert {B}_{n} ( kr ) \vert} > th & ( 9 )\end{matrix}$$

Note that it is sufficient if the threshold th in Formula (9) is a real number between zero and one, and a value close to one is favorable. Specifically, for example, the threshold th is set to 0.95. Further, in FIG. 3, FIGS. 5 to 8, and FIG. 10 described above, and in FIG. 12 described later, an order n₀(krₛ) that is defined using Formula (9) is used in all of the figures.

By performing such spatial resolution control, it becomes possible to improve the condition of a transformation matrix and to improve tolerance for an error. For example, with respect to the microphone arrays with the respective arrangements of a mike unit when spatial resolution is not controlled and when kr=6, the respective condition numbers X(k) of the transformation matrix Bₖ exhibit values illustrated in FIG. 11. Note that, in FIG. 11, the horizontal axis represents a frequency, and the vertical axis represents the condition number X(k).

In FIG. 11, a curve L21 to a curve L23 respectively represent the condition numbers of the circular microphone array, the vortex-shaped microphone array MA11 illustrated in FIG. 3, and the flower-shaped microphone array MA21 illustrated in FIG. 5.

This example shows that the condition numbers X(k) of the transformation matrix Bₖ for all of the microphone arrays are large in a low-frequency range.

This phenomenon occurs due to linear dependency caused by a redundant row of the transformation matrix Bₖ, and the microphone array according to the present technology makes it possible to cope with the phenomenon by performing spatial resolution control or an appropriate matrix regularization.

On the other hand, with respect to the microphone arrays with the respective arrangements of a mike unit when spatial resolution is controlled, the respective condition numbers X(k) of transformation matrix Bⁿ⁰ₖ exhibit values illustrated in FIG. 12. Note that, in FIG. 12, the horizontal axis represents a frequency, and the vertical axis represents the condition number X(k).

In FIG. 12, a curve L31 to a curve L33 respectively represent the condition numbers of the circular microphone array, the vortex-shaped microphone array MA11 illustrated in FIG. 3, and the flower-shaped microphone array MA21 illustrated in FIG. 5.

This example shows that the condition numbers X(k) of the transformation matrix Bⁿ⁰ₖ for all of the microphone arrays are smaller in a low-frequency range, compared to the example of FIG. 11.

Further, the condition number X(k) for the circular microphone array is large depending on frequency. Such worsening of the condition of the circular microphone array is its specific feature due to the value of a Bessel function becoming zero, and it is not solved by performing spatial resolution control or matrix regularization.

On the other hand, with respect to the vortex-shaped microphone array MA11 and the flower-shaped microphone array MA21, the respective condition numbers X(k) are not greater than 30 at most frequencies. This result shows that a better condition number is obtained by performing spatial resolution control on a microphone array with an appropriate mike-unit arrangement and tolerance for an error is improved.

### Example of Configurations of Recording System and Reproduction System

Next, an example of configurations of a recording system that records wavefront of sound (sound field) using the microphone array described above, and a reproduction system that reproduces the wavefront of sound on the basis of the spherical harmonic coefficient aₘₙ(k) obtained by the recording system, is described.

For example, such a recording system and such a reproduction system are configured as illustrated in FIG. 13.

In FIG. 13, the recording system includes a microphone array 11 and a recording apparatus 12, and the reproduction system includes a reproduction apparatus 13 and a speaker array 14.

Note that the microphone array 11 may be part of the recording apparatus 12, and the speaker array 14 may be part of the reproduction apparatus 13.

In the recording system, wavefront of sound is recorded by the microphone array 11 including a plurality of mike units, and a multichannel signal that is a signal of the sound that is obtained as a result of the recording is supplied to the recording apparatus 12. In other words, the microphone array 11 records wavefront of sound by collecting the sound using respective mike units, and outputs, as a multichannel signal, a signal that is an audio signal obtained by the collection of the sound performed using the respective mike units.

The microphone array 11 is used to record a sound field, that is, wavefront of sound, and includes a plurality of sub-arrays. Further, each sub-array includes a plurality of mike units. In particular, the microphone array 11 is a microphone array that has Features F1 to F3 described above, such as the microphone arrays illustrated in FIG. 3 and FIGS. 5 to 8, and the mike unit included in the microphone array 11 is an omnidirectional microphone.

The recording apparatus 12 calculates the spherical harmonic coefficient aₘₙ(k) using a multichannel signal supplied by the microphone array 11, and supplies the spherical harmonic coefficient aₘₙ(k) to the reproduction apparatus 13.

In this example, the recording apparatus 12 includes an input section 21, a time-frequency analyzer 22, a parameter holding section 23, a spatial resolution controller 24, and a spherical harmonic coefficient calculator 25.

The input section 21 performs analog-to-digital (AD) conversion on the multichannel signal supplied by microphone array 11 to convert the analog multichannel signal to a digital signal, and supplies the digital signal to the time-frequency analyzer 22.

The time-frequency analyzer 22 performs short-time Fourier transform (STFT) on the multichannel signal supplied by the input section 21, and supplies a time-frequency spectrum obtained as a result of performing the short-time Fourier transform to the spherical harmonic coefficient calculator 25. The time-frequency spectrum obtained by the time-frequency analyzer 22 corresponds to the sound pressure pₓ(rₗ, θₗ, φₗ) indicated in Formula (4).

The parameter holding section 23 holds the arrangement-parameter set P^{Q}ₒₚₜ determined on the basis of, for example, the total number of microphone units Q, the operation frequency range [fₘᵢₙ, fₘₐₓ], the diameter Dₘ of a mike unit, and the upper limit Xₘₐₓ of the condition number X(k) that are given in advance.

For example, the microphone array 11 is a microphone array having a shape determined by the arrangement-parameter set P^{Q}ₒₚₜ determined as described above, and the arrangement-parameter set P^{Q}ₒₚₜ related to the microphone array 11 is held by the parameter holding section 23. In other words, the arrangement-parameter set P^{Q}ₒₚₜ is geometry information indicating the mike-unit arrangement of the microphone array 11.

The parameter holding section 23 supplies the arrangement-parameter set P^{Q}ₒₚₜ held in the parameter holding section 23 to the spatial resolution controller 24 and the spherical harmonic coefficient calculator 25.

The spatial resolution controller 24 controls spatial resolution on the basis of the arrangement-parameter set P^{Q}ₒₚₜ supplied by the parameter holding section 23.

In other words, on the basis of a radius max(rₛ) of a sub-array included in the microphone array 11 that is determined according to the arrangement-parameter set P^{Q}ₒₚₜ, the spatial resolution controller 24 performs calculation of, for example, Formula (9) described above for each frequency, that is, for each wavenumber K to calculate (determine) the order n₀(k×max(rₛ)). Then, the spatial resolution controller 24 supplies the order n₀(k×max(rₛ)) obtained as described above to the spherical harmonic coefficient calculator 25, and instructs the spherical harmonic coefficient calculator 25 to limit the number of rows of the transformation matrix Bₖ.

The spherical harmonic coefficient calculator 25 calculates the spherical harmonic coefficient aₘₙ(k) using the time-frequency spectrum supplied by the time-frequency analyzer 22, the arrangement-parameter set P^{Q}ₒₚₜ supplied by the parameter holding section 23, and the order n₀(k×max(rₛ)) supplied by the spatial resolution controller 24.

For example, the spherical harmonic coefficient calculator 25 generates the transformation matrix Bⁿ⁰ₖ in which the number of rows is limited, in accordance with the instruction given by the spatial resolution controller 24. Specifically, as the transformation matrix Bⁿ⁰ₖ that is a final matrix, the spherical harmonic coefficient calculator 25 generates a matrix containing the first row to the n₀(k×max(rₛ))-th row of the transformation matrix Bₖ determined according to the arrangement-parameter set P^{Q}ₒₚₜ, that is, the mike-unit arrangement of the microphone array 11.

This transformation matrix Bⁿ⁰ₖ is generated for each wavenumber K, that is, for each SIFT bin, on the basis of the arrangement-parameter set P^{Q}ₒₚₜ that is geometry information of the microphone array 11, and the order n₀(k×max(rₛ)) that is output of the spatial resolution controller 24.

The spherical harmonic coefficient calculator 25 performs calculation as that of Formula (3) described above, on the basis of a pseudo-inverse matrix obtained with respect to the transformation matrix Bⁿ⁰ₖ, and on the basis of the time-frequency spectrum, and calculates the spherical harmonic coefficient aₘₙ(k). For example, the spherical harmonic coefficient calculator 25 uses the Moore-Penrose inverse as a pseudo-inverse matrix of the transformation matrix Bⁿ⁰ₖ. In other words, the Moore-Penrose inverse with respect to the transformation matrix Bⁿ⁰ₖ is calculated as a pseudo-inverse matrix of the transformation matrix Bⁿ⁰ₖ.

The spherical harmonic coefficient calculator 25 performs calculation similar to that of Formula (3) described above, and spherical harmonic transform (SHT) and mode compensation are performed at the same time in this calculation. The mode compensation in this case is processing corresponding to dividing pₖ(r, θ_{q}, φ_{q}) Y*^{m}ₙ(θ_{q}, φ_{q}) by bₙ(kr) in Formula (1), that is, processing of dividing, by a mode function (a Bessel function), a time-frequency spectrum on which spherical harmonic transform has been performed.

Note that, here, an example in which spherical harmonic transform and mode compensation are performed at the same time upon obtaining the spherical harmonic coefficient aₘₙ(k), is described, but the spherical harmonic transform and the mode compensation may be separately performed.

In such a case, the spherical harmonic coefficient calculator 25 is provided with a processing block for performing spherical harmonic transform and a processing block for performing mode compensation. Then, in the processing block for performing spherical harmonic transform, spherical harmonic transform is performed on a time-frequency spectrum, and, in the processing block for performing mode compensation, the time-frequency spectrum on which spherical harmonic transform has been performed is divided by a mode function (a Bessel function). Here, operation up to a term determined by the order n₀(k×max(rₛ)) is performed upon performing the spherical harmonic transform and the mode compensation.

Further, the spherical harmonic coefficient calculator 25 outputs (transmits) the calculated spherical harmonic coefficient aₘₙ(k) to the reproduction system.

In the reproduction system, a drive signal used to drive the speaker array 14 is generated on the basis of the spherical harmonic coefficient aₘₙ(k) output by the spherical harmonic coefficient calculator 25, and wavefront of sound is reproduced. The generation of a drive signal can be performed by correcting speaker characteristics of the speaker array 14 or by using the other algorithms.

For example, the reproduction apparatus 13 of the reproduction system includes a speaker-arrangement-information holding section 31, a drive signal generator 32, a time-frequency synthesizer 33, and an output section 34.

The speaker-arrangement-information holding section 31 holds speaker arrangement information that indicates the arrangement of a speaker included in the speaker array 14, and supplies the held speaker arrangement information to the drive signal generator 32.

The drive signal generator 32 receives the spherical harmonic coefficient aₘₙ(k) transmitted by the spherical harmonic coefficient calculator 25, generates a drive signal on the basis of the received spherical harmonic coefficient aₘₙ(k) and the speaker arrangement information supplied by the speaker-arrangement-information holding section 31, and supplies the generated drive signal to the time-frequency synthesizer 33.

For example, the drive signal generator 32 performs calculation of Formula (2) described above, and a signal that represents the sound pressure pₖ(r_{q}, θ_{q}, φ_{q}) is calculated as a drive signal in the time frequency domain. Note that, in the calculation of Formula (2), the value of a radius of a reproduction area that is a region for which wavefront of sound is reproduced is used as the radius r_{q}.

Further, in the calculation of Formula (2), multiplication of the spherical harmonic coefficient aₘₙ(k) by a Bessel function, that is, generation of a drive signal in a spherical harmonic domain, and inverse spherical harmonic transform (ISHT) with respect to the generated drive signal are performed at the same time. However, inverse spherical harmonic transform may be performed after a drive signal in a spherical harmonic domain is generated. In such a case, the drive signal generator 32 is provided with a processing block for generating a drive signal in a spherical harmonic domain and a processing block for performing inverse spherical harmonic transform.

The time-frequency synthesizer 33 performs inverse short-time Fourier transform (ISTFT) on the drive signal supplied by the drive signal generator 32, and supplies, to the output section 34, a drive signal in the time domain that is obtained as a result of performing the inverse short-time Fourier transform.

The output section 34 performs digital-to-analog conversion on the drive signal supplied by the time-frequency synthesizer 33, and supplies, to the speaker array 14, an analog drive signal obtained as a result of performing the digital-to-analog conversion. The speaker array 14 outputs sound on the basis of the drive signal supplied by the output section 34 to reproduce wavefront of the sound that is recorded by the recording system.

For example, the speaker array 14 is obtained by rectangularly arranging linear speaker arrays, each linear speaker array being obtained by linearly arranging speakers, and a region situated inside the speaker array 14 is a reproduction area for wavefront. Note that the speaker array 14 may have any shape, that is, the speaker array 14 may have any speaker arrangement.

### Description of Recording Processing

Next, operations of the recording system and the reproduction system that are illustrated in FIG. 13 are described.

First, recording processing performed by the recording system is described with reference to a flowchart of FIG. 14. Note that the arrangement-parameter set P^{Q}ₒₚₜ is determined in advance by the parameter holding section 23 or another processing block before the recording processing is started, and the arrangement-parameter set P^{Q}ₒₚₜ obtained as a result of the determination is held by the parameter holding section 23.

In Step S11, the spatial resolution controller 24 controls spatial resolution on the basis of the arrangement-parameter set P^{Q}ₒₚₜ supplied by the parameter holding section 23.

For example, the spatial resolution controller 24 performs calculation of, for example, Formula (9) described above to calculate the order n₀(k×max(rₛ)), supplies the calculated order n₀(k×max(rₛ)) to the spherical harmonic coefficient calculator 25, and instructs the spherical harmonic coefficient calculator 25 to limit the number of rows of the transformation matrix Bₖ.

In Step S12, the microphone array 11 collects ambient sound using a mike unit, and supplies a multichannel signal obtained as a result of the collection to the input section 21. The input section 21 performs AD conversion on the multichannel signal supplied by the microphone array 11, and supplies, to the time-frequency analyzer 22, the multichannel signal on which the AD conversion has been performed.

In Step S13, the time-frequency analyzer 22 performs short-time Fourier transform on the multichannel signal supplied by the input section 21, and supplies a time-frequency spectrum obtained as a result of performing the short-time Fourier transform to the spherical harmonic coefficient calculator 25.

In Step S14, the spherical harmonic coefficient calculator 25 calculates the spherical harmonic coefficient aₘₙ(k) on the basis of the time-frequency spectrum from the time-frequency analyzer 22, the arrangement-parameter set P^{Q}ₒₚₜ from the parameter holding section 23, and the order n₀(k×max(rₛ)) from the spatial resolution controller 24.

In other words, the spherical harmonic coefficient calculator 25 generates the transformation matrix Bⁿ⁰ₖ on the basis of the order n₀(k×max(rₛ)), in accordance with the instruction given by the spatial resolution controller 24, and calculates a pseudo-inverse matrix of the generated transformation matrix Bⁿ⁰ₖ. Then, the spherical harmonic coefficient calculator 25 performs calculation similar to that of Formula (3) on the basis of the obtained pseudo-inverse matrix and the time-frequency spectrum, and calculates the spherical harmonic coefficient aₘₙ(k).

The spherical harmonic coefficient calculator 25 outputs the spherical harmonic coefficient aₘₙ(k) calculated as described above, and the recording processing is terminated.

As described above, the recording system records wavefront using the microphone array 11 having a shape (a mike-unit arrangement) determined according to the arrangement-parameter set PQₒₚₜ, and calculates the spherical harmonic coefficient aₘₙ(k) using a transformation matrix obtained by controlling spatial resolution. This makes it possible to perform broadband sound field recording at low cost.

### Description of Reproduction Processing

Next, reproduction processing performed by the reproduction system is described with reference to a flowchart of FIG. 15. The reproduction processing is started when the drive signal generator 32 of the reproduction apparatus 13 receives the spherical harmonic coefficient aₘₙ(k) transmitted by the recording system.

In Step S41, the drive signal generator 32 generates a drive signal on the basis of the received spherical harmonic coefficient aₘₙ(k) and speaker arrangement information supplied by the speaker-arrangement-information holding section 31, and supplies the generated drive signal to the time-frequency synthesizer 33. For example, in Step S41, calculation of Formula (2) described above is performed, and a signal indicating the sound pressure pₖ(r_{q}, θ_{q}, φ_{q}) is calculated as a drive signal in the time frequency domain.

In Step S42, the time-frequency synthesizer 33 performs inverse short-time Fourier transform on the drive signal supplied by the drive signal generator 32, and supplies, to the output section 34, a drive signal in the time domain that is obtained as a result of performing the inverse short-time Fourier transform. Further, the output section 34 performs DA conversion on the drive signal supplied by the time-frequency synthesizer 33, and supplies, to the speaker array 14, an analog drive signal obtained as a result of performing the DA conversion.

In Step S43, the speaker array 14 outputs sound on the basis of the drive signal supplied by the output section 34 to reproduce wavefront of the sound that is recorded by the recording system, and the reproduction processing is terminated.

As described above, the reproduction system generates a drive signal from the received spherical harmonic coefficient aₘₙ(k), and reproduces wavefront of sound on the basis of the generated drive signal. The reproduction system makes it possible to perform broadband wavefront reproduction by reproducing wavefront on the basis of the spherical harmonic coefficient aₘₙ(k) received from the recording system.

### Example of Configuration of Computer

By the way, the series of processes described above can be performed using hardware or software. When the series of processes is performed using software, a program included the software is installed on a computer. Here, examples of the computer include a computer incorporated into dedicated hardware, and a computer such as a general-purpose personal computer that is capable of performing various functions by various programs being installed thereon.

FIG. 16 is a block diagram of an example of a configuration of hardware of a computer that performs the series of processes described above using a program.

In the computer, a central processing unit (CPU) 501, a read only memory (ROM) 502, and a random access memory (RAM) 503 are connected to one another through a bus 504.

Further, an input/output interface 505 is connected to the bus 504. An input section 506, an output section 507, a recording section 508, a communication section 509, and a drive 510 are connected to the input/output interface 505.

The input section 506 includes, for example, a keyboard, a mouse, a microphone array, and an imaging element. The output section 507 includes, for example, a display and a speaker array. The recording section 508 includes, for example, a hard disk and a nonvolatile memory. The communication section 509 includes, for example, a network interface. The drive 510 drives a removable recording medium 511 such as a magnetic disk, an optical disk, a magneto-optical disk, or a semiconductor memory.

In the computer having the configuration described above, for example, the series of processes described above is performed by the CPU 501 loading a program stored in the recording section 508 into the RAM 503 and executing the program via the input/output interface 505 and the bus 504.

For example, the program executed by the computer (the CPU 501) can be provided by being stored in the removable recording medium 511 serving as, for example, a package medium. Further, the program can be provided via a wired or wireless transmission medium such as a local area network, the Internet, or digital satellite broadcasting.

In the computer, the program can be installed on the recording section 508 via the input/output interface 505 by the removable recording medium 511 being mounted on the drive 510. Further, the program can be received by the communication section 509 via the input/output interface 505 to be installed on the recording section 508. Moreover, the program can be installed in advance on the ROM 502 or the recording section 508.

Note that the program executed by the computer may be a program in which processes are chronologically performed in the order described herein, or may be a program in which processes are performed in parallel or a process is performed at a necessary timing such as a timing of calling.

Further, the embodiment of the present technology is not limited to the examples described above, and various modifications may be made thereto without departing from the scope of the present technology.

For example, the present technology may also have a configuration of cloud computing in which a plurality of apparatuses shares tasks of a single function and works collaboratively to perform the single function via a network.

Furthermore, the respective steps described using the flowchart described above may be shared by a plurality of apparatuses to be performed, in addition to being performed by a single apparatus.

Moreover, when a single step includes a plurality of processes, the plurality of processes included in the single step may be shared by a plurality of apparatuses to be performed, in addition to being performed by a single apparatus.

Further, the present technology may also take the following configurations.

(1) A microphone array used for sound field recording, including

a plurality of sub-arrays each including a plurality of microphones, and each having a discretely rotationally symmetric shape having a specified radius, in which
when values of the radiuses of the plurality of sub-arrays form a progression, the progression is a generalized arithmetic progression.
(2) The microphone array according to (1), in which

each of the plurality of microphones included in the sub-array is arranged away from a center position of the microphone array by a distance corresponding to the radius of the sub-array.

(3) The microphone array according to (1) or (2), in which

one of the plurality of sub-arrays coincides with another of the plurality of sub-arrays when at least one of an enlargement operation, a reduction operation, a rotation operation, or a reverse operation is performed on the one of the plurality of sub-arrays.

(4) The microphone array according to any one of (1) to (3), in which

the plurality of microphones is arranged such that when all of the microphones of the plurality of microphones included in the microphone array are radially projected onto a ring shape centered at a center position of the microphone array, the projected microphones of the plurality of microphones are equally spaced on the ring shape.

(5) The microphone array according to any one of (1) to (4), in which

all of the microphones of the plurality of microphones included in the microphone array are omnidirectional microphones, or at least one of the plurality of microphones included in the microphone array is not an omnidirectional microphone.

(6) A recording apparatus, including

a spherical harmonic coefficient calculator that calculates a spherical harmonic coefficient on the basis of a multichannel signal obtained by sound collection being performed by a microphone array used for sound field recording, the microphone array including a plurality of sub-arrays each including a plurality of microphones, and each having a discretely rotationally symmetric shape having a specified radius, in which

when values of the radiuses of the plurality of sub-arrays form a progression, the progression is a generalized arithmetic progression.

(7) The recording apparatus according to (6), in which

the spherical harmonic coefficient calculator calculates the spherical harmonic coefficient by performing mode compensation.

(8) The recording apparatus according to (7), further including

a spatial resolution controller that limits the number of rows of a transformation matrix used to perform the mode compensation, on the basis of a specified order of a spherical harmonic domain.

(9) The recording apparatus according to (8), in which

the spatial resolution controller determines the specified order on the basis of a maximum value of the radiuses of the plurality of sub-arrays.

(10) The recording apparatus according to (8) or (9), in which

the spherical harmonic coefficient calculator calculates the spherical harmonic coefficient by performing the mode compensation, on the basis of a pseudo-inverse matrix of the transformation matrix in which the number of rows is limited, and the multichannel signal.

(11) A recording method, including

calculating, by a recording apparatus, a spherical harmonic coefficient on the basis of a multichannel signal obtained by sound collection being performed by a microphone array used for sound field recording, the microphone array including a plurality of sub-arrays each including a plurality of microphones, and each having a discretely rotationally symmetric shape having a specified radius, in which

when values of the radiuses of the plurality of sub-arrays form a progression, the progression is a generalized arithmetic progression.

(12) A program that causes a computer to perform a process including

calculating a spherical harmonic coefficient on the basis of a multichannel signal obtained by sound collection being performed by a microphone array used for sound field recording, the microphone array including a plurality of sub-arrays each including a plurality of microphones, and each having a discretely rotationally symmetric shape having a specified radius, in which

when values of the radiuses of the plurality of sub-arrays form a progression, the progression is a generalized arithmetic progression.

### REFERENCE SIGNS LIST

11 microphone array
12 recording apparatus
22 time-frequency analyzer
23 parameter holding section
24 spatial resolution controller
25 spherical harmonic coefficient calculator

1. A microphone array used for sound field recording, comprising:
a plurality of sub-arrays each including a plurality of microphones, and each having a discretely rotationally symmetric shape having a specified radius, wherein
when values of the radiuses of the plurality of sub-arrays form a progression, the progression is a generalized arithmetic progression.

2. The microphone array according to claim 1, wherein
each of the plurality of microphones included in the sub-array is arranged away from a center position of the microphone array by a distance corresponding to the radius of the sub-array.

3. The microphone array according to claim 1, wherein
one of the plurality of sub-arrays coincides with another of the plurality of sub-arrays when at least one of an enlargement operation, a reduction operation, a rotation operation, or a reverse operation is performed on the one of the plurality of sub-arrays.

4. The microphone array according to claim 1, wherein
the plurality of microphones is arranged such that when all of the microphones of the plurality of microphones included in the microphone array are radially projected onto a ring shape centered at a center position of the microphone array, the projected microphones of the plurality of microphones are equally spaced on the ring shape.

5. The microphone array according to claim 1, wherein
all of the microphones of the plurality of microphones included in the microphone array are omnidirectional microphones, or at least one of the plurality of microphones included in the microphone array is not an omnidirectional microphone.

6. A recording apparatus, comprising
a spherical harmonic coefficient calculator that calculates a spherical harmonic coefficient on a basis of a multichannel signal obtained by sound collection being performed by a microphone array used for sound field recording, the microphone array including a plurality of sub-arrays each including a plurality of microphones, and each having a discretely rotationally symmetric shape having a specified radius, wherein
when values of the radiuses of the plurality of sub-arrays form a progression, the progression is a generalized arithmetic progression.

7. The recording apparatus according to claim 6, wherein
the spherical harmonic coefficient calculator calculates the spherical harmonic coefficient by performing mode compensation.

8. The recording apparatus according to claim 7, further comprising
a spatial resolution controller that limits the number of rows of a transformation matrix used to perform the mode compensation, on a basis of a specified order of a spherical harmonic domain.

9. The recording apparatus according to claim 8, wherein
the spatial resolution controller determines the specified order on a basis of a maximum value of the radiuses of the plurality of sub-arrays.

10. The recording apparatus according to claim 8, wherein
the spherical harmonic coefficient calculator calculates the spherical harmonic coefficient by performing the mode compensation, on a basis of a pseudo-inverse matrix of the transformation matrix in which the number of rows is limited, and the multichannel signal.

11. A recording method, comprising
calculating, by a recording apparatus, a spherical harmonic coefficient on a basis of a multichannel signal obtained by sound collection being performed by a microphone array used for sound field recording, the microphone array including a plurality of sub-arrays each including a plurality of microphones, and each having a discretely rotationally symmetric shape having a specified radius, wherein
when values of the radiuses of the plurality of sub-arrays form a progression, the progression is a generalized arithmetic progression.

12. A program that causes a computer to perform a process comprising
calculating a spherical harmonic coefficient on a basis of a multichannel signal obtained by sound collection being performed by a microphone array used for sound field recording, the microphone array including a plurality of sub-arrays each including a plurality of microphones, and each having a discretely rotationally symmetric shape having a specified radius, wherein
when values of the radiuses of the plurality of sub-arrays form a progression, the progression is a generalized arithmetic progression.
